(19) United States
(12) Patent Application Publication
(10) Pub. No.: US 2006/0168370 A1
(43) Pub. Date: Jul. 27, 2006

(54) Removable identity circuit for a networked appliance

(76) Inventors: Larry A. Dew, Haslet, TX (US); Todd C. Wheaton, Wake Forest, NC (US); Tim Miller, Clayton, NC (US); Jackie Laverne Winn, Raleigh, NC (US)

Correspondence Address: SQUARE D COMPANY;LEGAL DEPARTMENT - I.P. GROUP, 1415 SOUTH ROSELLE ROAD, PALATINE, IL, 60067, US

(21) Appl. No.: 11/013,752

(22) Filed: Dec. 16, 2004

(51) Int. Cl. G06F 3/00; G06F 3/02

(52) U.S. Cl. 710/49

(57) ABSTRACT

The instant invention is directed to a variety of networked appliances, including equipment controlled or monitored via an Ethernet connection in industrial applications. In one example embodiment of the present invention, a networked industrial-application appliance, having a processor, includes a removable modular circuit board and a memory arrangement. The removable modular circuit board includes an identity circuit memory, an external-connection port for providing communication access between the networked industrial-application appliance processor and the identity circuit memory, and electrical conductors each of which is adapted to provide a connection with the external-connection port. The memory arrangement includes a nonvolatile memory device and is adapted to store an identity profile that is particular to the networked industrial-application appliance. The networked industrial-application appliance processor is communicatively-coupled to the identity circuit memory via the external-connection port and to the identity profile in the nonvolatile memory.

### FIELD OF THE INVENTION

The present invention is directed to industrial appliances that are connected to a communication network.

### BACKGROUND

Industrial equipment, such as welders, can be connected to a communication network. The network connection for industrial equipment allows the operation of the industrial equipment to be monitored and controlled by a device located anywhere in the communications network.

While the network connection for industrial equipment provides remote monitoring and control of the operation of the industrial equipment, the network connection increases the difficulty of servicing the industrial equipment. For example, replacement of faulty industrial equipment requires reconfiguration of the communications network because the replacement equipment typically has a physical network address that is different from the replaced faulty equipment. The reconfiguration of the communications network typically requires manual processes that are inconvenient, time consuming, and prone to error.

These and other considerations have presented challenges to networked appliances. Networked industrial equipment, and networked appliances in general, that allow servicing without inconvenient, time consuming, and error prone manual processes are needed.

### SUMMARY

The present invention is directed to overcoming the above-mentioned challenges and others related to the types of devices and applications discussed above and in other applications. The present invention is exemplified in a number of implementations and applications, some of which are summarized below.

According to an example embodiment of the present invention, a networked industrial-application appliance, having a processor, also includes a removable modular circuit board and a memory arrangement. The removable modular circuit board includes an identity circuit memory, an external-connection port for providing communication access between the networked industrial-application appliance processor and the identity circuit memory, and electrical conductors each of which is adapted to provide a connection with the external-connection port. The memory arrangement includes a nonvolatile memory device and is adapted to store an identity profile that is particular to the networked industrial-application appliance. The networked industrial-application appliance processor is communicatively-coupled to the identity circuit memory via the external-connection port and to the identity profile in the nonvolatile memory.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention in connection with the accompanying drawings, in which:

FIG. 1 is a block diagram of a networked appliance that uses an identity circuit, according to an example embodiment of the present invention;

FIG. 2 is a block diagram of an Ethernet welder that uses an identity circuit, according to another example embodiment of the present invention;

FIG. 3 is a block diagram of an identity circuit, according to an example embodiment of the present invention; and

FIG. 4 is a flow diagram of a process for using information from an identity circuit to establish the identity of a networked appliance, according to an example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of networked appliances, and has been found to be particularly useful for equipment controlled or monitored via an Ethernet connection in an industrial application. For instance, example embodiments of the present invention are applicable Ethernet enabled weld controllers. While the present invention is not necessarily limited to such applications, various aspects of the invention may be appreciated through a discussion of various examples using this context.

According to an example embodiment of the present invention, a removable identity circuit is used to provide profile data such as the physical network address for the networked appliance. During power-up or reset of the networked appliance, the profile information is read from the identity circuit and used to initialize the configuration of the networked appliance such as the physical network address used by a network controller of the networked appliance. Transferring the removable identity circuit from a first networked appliance to a second networked appliance allows the second networked appliance to assume the identity of the first networked appliance without reconfiguration of the communication network. One example of such transferring of the removable identity circuit occurs during replacement of a first, faulty networked appliance with a second networked appliance, allowing the faulty first networked appliance to be replaced without reconfiguration of the communication network.

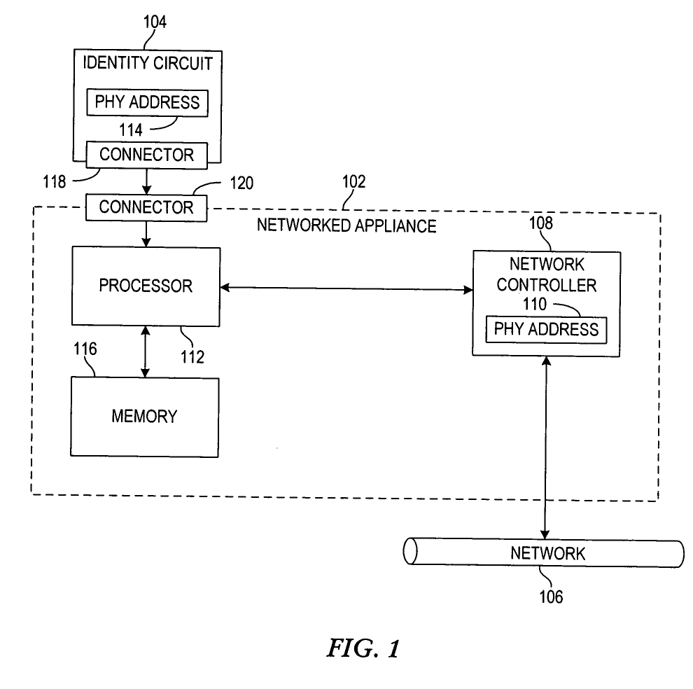

FIG. 1 is a block diagram of a networked appliance 102 that uses an identity circuit 104, according to an example embodiment of the present invention. The operation of the networked appliance 102 may be monitored and controlled by devices on the network 106. The networked appliance 102 communicates with the network 106 via a network controller 108 which may implement the lower layers of the network communication protocol. The network controller 108 includes a physical address 110 that is used to identify the network controller 108, and hence the networked appliance 102. The physical address 110 may be a globally unique identifier.

The processor 112 may control the networked appliance 102 and the network controller 108. The network controller 108 may implement the physical address 110 as a register having a value that may be written by the processor 112. The processor 112 may write such a network physical address 110 with a physical address value 114 obtained from the identity circuit 104. For example, the startup boot code in memory 116 for the processor 112 may read the physical address value 114 from the identity circuit 104 and write the physical address value 114 to the register of the network controller 108 for the physical address 110.

In one example embodiment, the identity circuit 104 includes a connector 118 that permits the identity circuit 104 to be coupled to a matching connector 120 on the networked appliance 102. The connectors 118 and 120 may be keyed such that there is only one possible way to connect the identity circuit 104 to the networked appliance 102. The identity circuit 104 may be removed from the networked appliance 102 by separating connector 118 from connector 120. The identity circuit 104 may be transferred to a second networked appliance, thereby transferring the value for the physical address 114 to the second networked appliance. The matching connector 120 may be located on the exterior of a cabinet for the networked appliance 102, or in another easily accessible location to expedite transfer of the identity circuit 104 to a second networked appliance. Servicing of a networked appliance 102, such as replacement of a faulty networked appliance 102 by a second networked appliance, may be simplified by the transfer of the identity circuit 104 to the second networked appliance.

According to another embodiment, the transfer of the identity circuit 104 to the second networked appliance eliminates the network 106 reconfiguration that is typically required when a networked appliance 102 is replaced by a second networked appliance having a distinct physical address. The transfer of the identity circuit 104 to a second networked appliance eliminates reconfiguring the name server, such as a dynamic host configuration protocol (DCHP) server, to map the network address, such as an internet protocol (IP) address, to the distinct physical address, and in addition, eliminates the messages of the address resolution protocol (ARP) required by all devices on the network 106 in communication with the networked appliance 102.

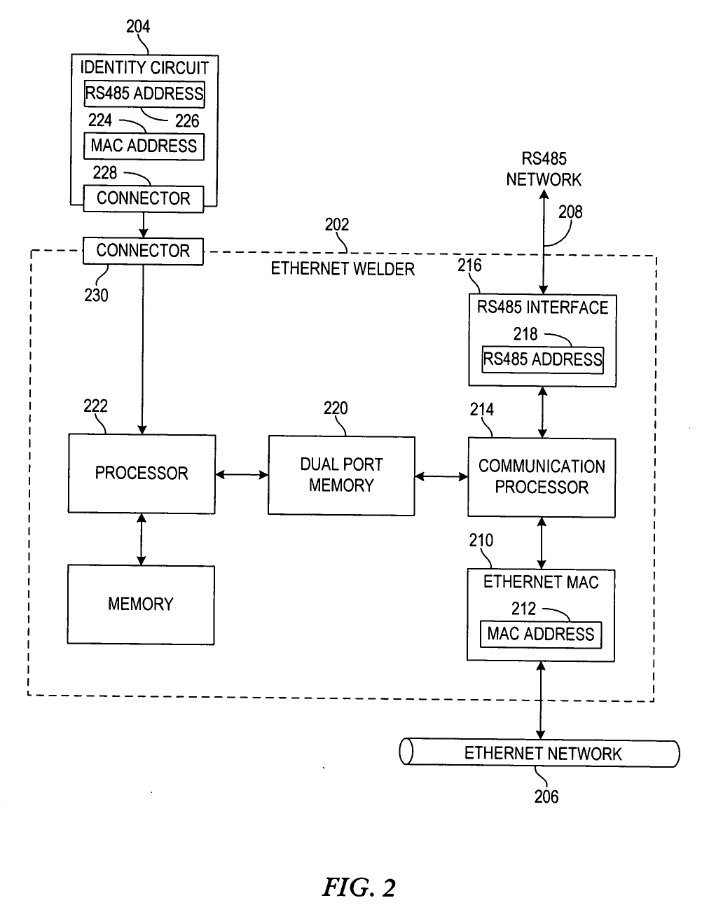

FIG. 2 is a block diagram of an Ethernet welder 202 that uses an identity circuit 204, according to another example embodiment of the present invention. The Ethernet welder 202 may communicate with an Ethernet network 206 and a RS-485 network 208. The operation of the Ethernet welder 202 may be monitored or controlled over either the Ethernet network 206 or the RS-485 network 208.

The Ethernet welder 202 includes an Ethernet media access controller (MAC) 210 to control communication with the Ethernet network 206. The Ethernet MAC 210 includes a MAC address 212 which may be implemented as a register that may be written by communication processor 214.

The Ethernet welder 202 includes a RS-485 interface 216 to control communication with the RS-485 network 208. The RS-485 interface 216 includes an RS-485 address 218 which may be implemented as a register that may be written by communication processor 214.

The dual port memory 220 may implement communication channels such as one or more FIFO queues between the communication processor 214 and the processor 222. Control of the operation of the Ethernet welder 202 may be divided between the communication processor 214 and the processor 222 with the communication processor 214 being primarily responsible for communication with external devices.

The communication processor 214 and the processor 222 may cooperate to transfer the MAC address value 224 from the identity circuit 204 to the register for the MAC address 212 in the Ethernet MAC 210. The communication processor 214 and the processor 222 may cooperate to transfer the RS-485 address value 226 from the identity circuit 204 to the register for the RS-485 address 218 of the RS-485 interface 216. The transfer of the MAC address value 224 and RS-485 address value 226 from the identity circuit 204 to the Ethernet MAC 210 and RS-485 interface 216, respectively, can occur during Ethernet welder 202 initialization, such as during the startup booting of the Ethernet welder 202.

The identity circuit 204 includes a keyed connector 228 that mates with a corresponding keyed connector 230 on the Ethernet welder 202. The identity circuit 204 may be removed from the Ethernet welder 202 and transferred to a second Ethernet welder, thereby transferring the MAC address value 224 and the RS-485 address value 226 to the second Ethernet welder.

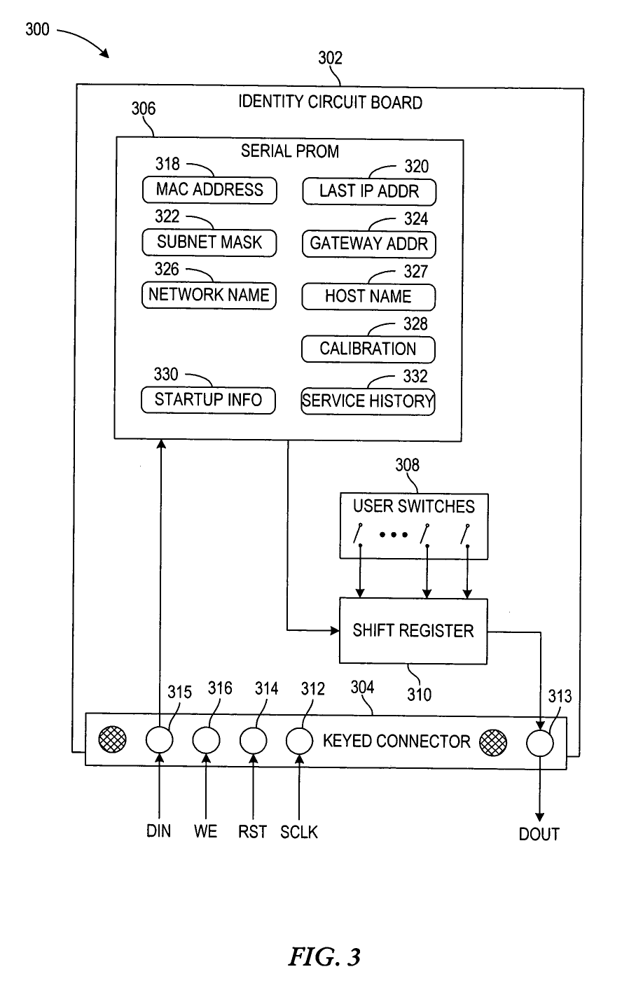

FIG. 3 is a block diagram of an identity circuit 300, according to an example embodiment of the present invention. The identity circuit 300 includes a printed circuit board (PCB) 302 that provides a set of pads corresponding to each of the devices 306, 308, and 310, and optionally, connector 304, and provides the electrical connections between these pads. Each of the devices 306, 308, and 310, and optionally, connector 304, is mechanically and electrically connected to the corresponding set of pads.

The identity circuit 300 may be coupled to a networked appliance via connector 304. Connector 304 may be keyed to prevent unintended coupling of the identity circuit 300 with the networked appliance. Connector 304 may be a connector device or an edge connector that is integrated into printed circuit board 302. A serial communication protocol may be used to access the identity circuit 300, with access being read and/or write access. The serial communication protocol has a shift clock on pin 312 to control the serial data transfer. The serial communication protocol has a data-out on pin 313 used to serially transfer data from the identity circuit 300 to the networked appliance under control of the shift clock on pin 312. The serial communication protocol may have a protocol reset on pin 314 and can additionally have a data-in pin 315 to transfer data to the identity circuit 300 under control of the shift clock on pin 312. A write enable pin 316 may enable writing serial PROM 306 with serial data supplied at the data-in pin 315. A networked appliance may not connect to the data-in pin 315 and/or the write enable pin 316 to prevent changing of the contents of the identity circuit 300 by the networked appliance, and a separate programmer for the identity circuit 300 may connect to the data-in pin 315 and the write enable pin 316 to initialize the contents of the identity circuit 300. Alternatively, the serial PROM 306 may be protected by a password to prevent unauthorized modification of the contents of the identity circuit 300.

In another embodiment, the identity circuit 300 stores profile data accessed by a networked appliance through the keyed connector 304 via a serial communication protocol. The profile data is stored in the serial PROM 306 or other nonvolatile memory device and the user switches 308. The serial PROM may include profile data for an identity profile such as network address information and operation information for the networked appliance. The network address information may include the physical MAC address 318 for an Ethernet network associated with the networked appliance, the last IP address 320 mapped to the networked appliance, the subnet mask 322 of the Ethernet network directly associated with the networked appliance that is used to determine whether or not a device IP address corresponds to a device located on the same subnet, a gateway IP address 324 used to access a device that is not located on the same subnet, and the network name 326 for the networked appliance. Additionally, identity circuit 300 may contain the host name 327 for the networked appliance so networks that use DNS services do not have to be refreshed on changing the host name. The operational information may include calibration information 328 for the networked appliance including calibration information about the environment of the networked appliance, startup information 330 such as a boot path for the software of the networked appliance, service history 332 for the networked appliance such as a revision date code, and customer preference settings for the networked appliance (not shown). The user switches 308 may be used to store additional profile data such as the RS-485 address for a RS-485 network associated with the networked appliance and additional customer preference settings.

Shift register 310 is used to introduce the value of the user switches 308 into the serial communication protocol for the profile data of the identity circuit 300. The values provided by the user switches 308 may be stored in parallel in the shift register 310 during a reset operation based on the reset signal on pin 314 of connector 304. After reset, based on the reset signal on pin 314, the first data shifted out of the identity circuit 300 on data-out pin 313 are the values of the user switches 308. As the values of the user switches 308 are shifted out on data-out pin 313, profile data from the serial PROM 306 is shifted into the shift register 310, such that the profile data from the serial PROM 306 is shifted out on data-out pin 313 following the values for the user switches 308. It will be appreciated that the order can be reversed on the shift chain for the serial PROM 306 and the shift register 310.

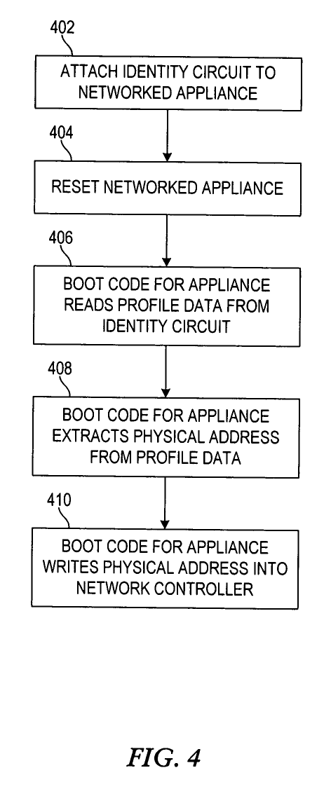

FIG. 4 is a flow diagram of a process for using information from an identity circuit to establish the identity of a networked appliance, according to an example embodiment of the present invention. At step 402, the identity circuit is coupled to the networked appliance. At step 404, the networked appliance is reset, such as may occur during power-up of the networked appliance. After reset of the networked appliance at step 404, one or more processors of the networked appliance may begin executing startup boot code. The boot code obtains profile data from the identity circuit at step 406. The boot code determines the physical address for the networked appliance from the profile data at step 408. The boot code writes the physical address for the networked appliance into a network controller of the networked appliance at step 410.

In addition, a variety of other ways of providing a transferable identity for a device such as a networked appliance may be performed using the approaches discussed herein.

The various embodiments described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to, eliminating the user switches and associated shift register, providing general user selected configurations for the networked appliance via the user switches, providing the RS-485 network address in the serial PROM, or providing a value for a profile data item that may be overridden as selected by the user switches with a value specified by the user switches. Such modifications and changes do not depart from the true spirit and scope of the present invention that is set forth in the following claims.

What is claimed is:

1. A networked industrial-application appliance, having a processor, comprising:
a removable modular circuit board having an identity circuit memory and having an external-connection port for providing communication access between the processor of the networked industrial-application appliance and the identity circuit memory, and having electrical conductors each adapted to provide a connection with the external-connection port; and
a memory arrangement including a nonvolatile memory device, being adapted to store an identity profile particular to the networked industrial-application appliance, the processor of the networked industrial-application appliance being communicatively-coupled to the identity circuit memory via the external-connection port and to the identity profile in the nonvolatile memory.

2. The networked industrial-application appliance of claim 1, wherein the identity profile includes operation information for the networked industrial-application appliance.

3. The networked industrial-application appliance of claim 2, wherein the operation information includes at least one of calibration information, startup information, service information, and customer preference settings.

4. The networked industrial-application appliance of claim 3, wherein the memory arrangement further includes a switch device adapted to store a portion of the identity profile.

5. The networked industrial-application appliance of claim 4, wherein the memory arrangement further includes an access device adapted to transfer the portion of the identity profile to the external-connection port.

6. The networked industrial-application appliance of claim 5, wherein the nonvolatile memory device, the switch device, and the access device are mechanically and electrically connected to corresponding pads on the removable modular circuit board.

7. The networked industrial-application appliance of claim 6, wherein the removable modular circuit board has further electrical conductors, each adapted to provide a connection between at least two of the pads.

8. The networked industrial-application appliance of claim 7, wherein the identity profile further includes network address information for the networked industrial-application appliance.

9. The networked industrial-application appliance of claim 8, wherein the network address information includes at least one of media access controller (MAC) address, last internet protocol (IP) address, sub-network mask value, gateway IP address, network name for the networked industrial-application appliance, and RS-485 address.

10. The networked industrial-application appliance of claim 9, wherein at least a portion of the identity profile is serially accessible to the processor.

11. The networked industrial-application appliance of claim 10, wherein the access device is a shift register device.

12. The networked industrial-application appliance of claim 11, wherein the networked industrial-application appliance is a network enabled weld controller.

13. The networked industrial-application appliance of claim 12, wherein the removable modular circuit board includes a connector for the external-connection port.

14. The networked industrial-application appliance of claim 13, wherein the connector is keyed to allow a unique coupling with the networked industrial-application appliance.

15. The networked industrial-application appliance of claim 11 further including,
a connector device for the external-connection port, wherein the pads of the removable modular circuit board include pads for the connector component.

16. The networked industrial-application appliance of claim 15, wherein the connector device is keyed to allow a unique coupling with the networked industrial-application appliance.

17. A networked industrial-application appliance with a physical network address provided by an identity circuit, comprising:
a network controller adapted to couple the networked industrial-application appliance to a communications network, wherein the physical network address for the network controller is configurable;
the identity circuit detachably coupled to the networked industrial-application appliance and adapted to store an identity profile for the networked industrial-application appliance, wherein the identity profile includes a value for the physical network address for the network controller; and
a processor arranged to configure the physical network address for the network controller with the value for the physical network address obtained from the identity circuit.

18. The networked industrial-application appliance of claim 17, wherein the networked industrial-application appliance is a network enabled weld controller.

19. A method for establishing a physical network address for a networked industrial-application appliance, comprising:
attaching a detachable identity circuit to the networked industrial-application appliance;
resetting the networked industrial-application appliance; and
executing boot code on a processor of the networked industrial-application appliance including,
reading data from the detachable identity circuit,
producing the physical network address from the data, and
configuring the networked industrial-application appliance with the physical network address.

20. The method of claim 19, wherein the networked industrial-application appliance is a network enabled weld controller.
